(19) United States
(12) Patent Application Publication
(10) Pub. No.: US 2013/0211905 A1
(43) Pub. Date: Aug. 15, 2013

(54) ATTRACTIVENESS-BASED ONLINE ADVERTISEMENT CLICK PREDICTION

(71) Applicants: Tao Qin, Beijing (CN); Tie-Yan Liu, Beijing (CN); Sungchul Kim, POHANG (KR)

(72) Inventors: Tao Qin, Beijing (CN); Tie-Yan Liu, Beijing (CN); Sungchul Kim, POHANG (KR)

(73) Assignee: MICROSOFT CORPORATION, Redmond, WA (US)

(21) Appl. No.: 13/372,358

(22) Filed: Feb. 13, 2012

(51) Int. Cl. G06Q 30/02

(52) U.S. Cl. 705/14.41

(57) ABSTRACT

The probability that a user clicks on an online advertisement may be dependent on an attractiveness of the online advertisement. In determining such click probability, an advertisement attractiveness model for estimating an attractiveness of an online advertisement to users may be developed. A click behavior model is then created by combining the advertisement attractiveness model with a relevance model. The relevance model may be used for estimating relevance between the online advertisement and a search query. The click behavior model may be applied to features extracted from the online advertisement to calculate a click probability for the online advertisement.

### BACKGROUND

In response to a search query, an online search engine may provide sponsored search results in the form of online advertisements along with general web search results. The online advertisements may be displayed in order according to their estimated click-through rates and the advertising fees paid by the advertisers. When a user clicks on an advertisement, the advertiser may pay the search engine provider a fee for the click. This revenue model is referred to as the pay-per-click model. Generally speaking, the pay-per-click model is based on the assumption that advertisement clicks are very important to both search engine providers and advertisers. For example, the clicks on advertisements provides revenue for the search engine provider, and for advertisers, the clicks on advertisements mean potential customers and purchases.

### SUMMARY

Described herein are techniques for determining the attractiveness of an online advertisement to users, and predicting a user click probability by taking into account both the relevance of the online advertisement to a user search query and the attractiveness of the online advertisement.

The relevance between a search query and an online advertisement may be one of the important factors in explaining user advertisement click behaviors. However, relevance is not the only factor in determining whether a user will click on an online advertisement. In some instances, an online advertisement that is well matched to a query may have a lower click through rate and click numbers than another online advertisement that does not match the query as well. An additional factor that affects whether a user will click on an online advertisement may be the attractiveness of the online advertisement to the user. The attractiveness of an online advertisement may be contingent upon the ability the words in the online advertisement to attract the attention of users. The techniques describes herein may provide a way to quantify the attractiveness of an online advertisement, and predict a probability that a user may click on the online advertisement based on the attractiveness of the advertisement in conjunction with the relevance of the online advertisement to a search query.

In at least one embodiment, an advertisement attractiveness model for estimating an attractiveness of an online advertisement to users may be developed. A click behavior model is then created by combining the advertisement attractiveness model with a relevance model. The relevance model may be used for estimating relevance between the online advertisement and a search query. The click behavior model may be applied to features extracted from the online advertisement to calculate a click probability for the online advertisement.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram that illustrates an example scheme that implements a user click inference engine that predicts a use click probability for an online advertisement.

FIG. 2 is an illustrative diagram that shows the example components of a user click inference engine.

FIG. 3 is a flow diagram that illustrates an example process for developing and using a click behavior model to infer a click probability of an online advertisement.

FIG. 4 is a flow diagram that illustrates an example process for generating a word-level attractiveness model and an advertisement attractiveness model.

FIG. 5 is a flow diagram that illustrates an example process for inferring a click probability of an online advertisement based on relevance features and attractiveness features of an online advertisement.

### DETAILED DESCRIPTION

The embodiments described herein pertain to techniques for determining the attractiveness of an online advertisement to users, and predicting a user click probability by taking into account both the relevance of the online advertisement to a user search query and the attractiveness of the online advertisement.

The relevance between a search query and an advertisement may be one of the important factors in explaining user advertisement click behaviors. However, relevance is not the only factor in determining whether a user will click on an advertisement. An additional factor that affects whether a user will click on an online advertisement may be the attractiveness of the online advertisement to the user. The attractiveness of an online advertisement may be contingent upon the ability the words in the online advertisement to attract the attention of a user.

In various embodiments, the attractiveness of an online advertisement may be quantified using an advertisement attractiveness model. The advertisement attractiveness model may be developed from a word-level attractiveness model that measures the attractiveness of individual words in the online advertisement. Further, the probability that the online advertisement may be clicked on by a user may be quantified using a click behavior model that is developed based on the advertisement attractiveness model and a relevance model. The relevant model may quantify the relevance between the online advertisement and a search query submitted by the user.

Accordingly, the implementation of the models to an online advertisement may produce word-level attractiveness scores that measure the attractiveness of words in the online advertisement to users. The implementation may further produce an advertisement attractiveness score that measure the overall attractiveness of the online advertisement to users. The implementation may additionally produce a click probability that measures the likelihood that the user will click on the online advertisement given the attractiveness of the online advertisement and the relevance of the online advertisement to a search query of the user.

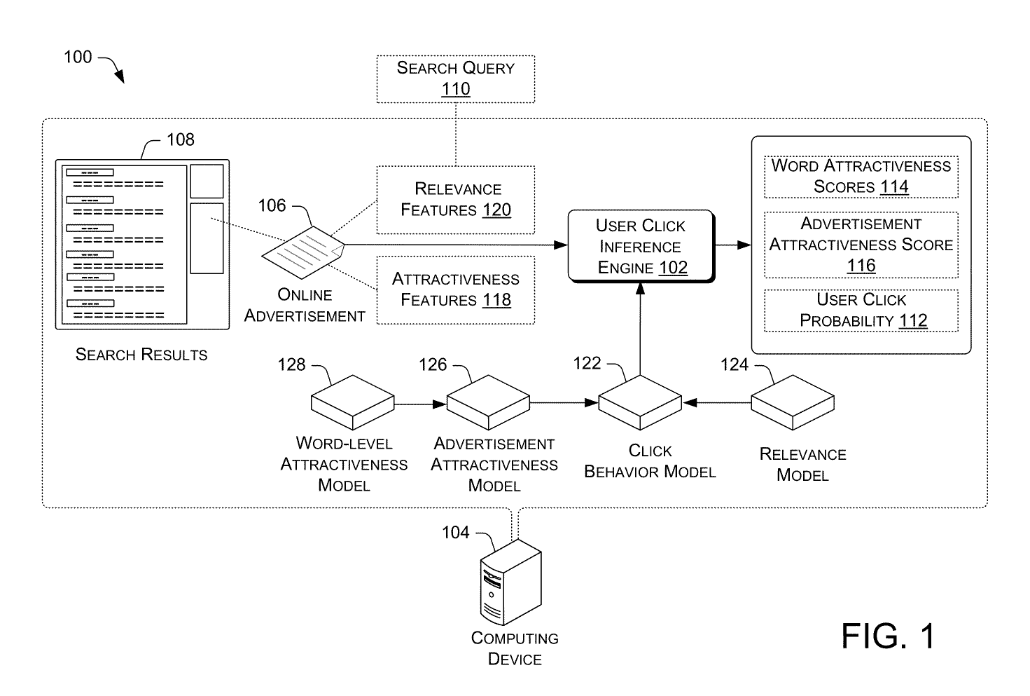

The scores that are produced by the techniques described herein may be used by the online advertisers to gauge the effectiveness of their online advertisements in attracting user attention. Accordingly, rather than simply improving the relevance of their online advertisement to user search queries, the online advertisers may alternatively or concurrently improve the content attractiveness of their online advertisements to increase the number of user clicks on their online advertisements. Various examples of techniques for implementing attractiveness-based online advertisement click prediction in accordance with the embodiments are described below with reference to FIGS. 1-5.

### Example Scheme

FIG. 1 is a block diagram that illustrates an example scheme 100 for implementing a user click inference engine 102 that performs attractiveness-based online advertisement click prediction. The user click inference engine 102 may be implemented by a computing device 104. The user click inference engine 102 may analyze an online advertisement 106. The online advertisement 106 may be an advertisement that is intended for display with a list of search results 108 that are generated for a search query 110. Accordingly, the online advertisement 106 may have some relevance to the search query 110.

The analysis of the online advertisement 106 may enable the user click inference engine 102 to generate a user click probability 112 for the online advertisement 106. The user click probability 112 may be generated based on the attractiveness of the words in the online advertisement 106 and the relevance of the online advertisement 106 to the search query 110. The user click probability 112 may represent the likelihood that a user may click on the online advertisement 106 when the online advertisement 106 is displayed as a sponsored search result with the list of search results 108.

In addition to the user click probability 112, the user click inference engine 102 may also provide word attractiveness scores 114 and an advertisement attractiveness score 116 for the online advertisement 106. Each of the word attractiveness score 114 may quantify the appeal of a corresponding word in the online advertisement 106 to users. The advertisement attractiveness score 116 may quantify the overall appeal of the online advertisement 106 to users.

In operation, the user click inference engine 102 may extract a set of attractiveness features 118 from each word in the online advertisement 106. The extracted attractiveness feature for a word may include two types of features. The first type of features may be textual features, such as the position of the word in an online advertisement, the length of the word, the part of speech (POS) of the word, and so forth. The second type of features for each word may be features that are extracted from the online advertisement 106 based on a historic record of user impressions and clicks, which may represent prior user preferences on words in online advertisements.

The user click inference engine 102 may also extract a set of relevance features 120 that quantify the relevance of the online advertisement 106 to the search query 110. The extracted relevance features 120 may include features that are visible to users, such as word frequency, inverse document frequency, topical page rank, and/or so forth, which are extracted by using the query words of a search query and content of the online advertisement 106. In some embodiments, the extracted relevance features 120 may exclude features that are invisible to users, such as bid keywords and/or content of an advertisement landing page that displays the online advertisement 106.

The user click inference engine 102 may generate the user click probability 112 for the online advertisement 106 using a click behavior model 122. In various embodiments, the click behavior model 122 may be developed from a relevance model 124 and an advertisement attractiveness model 126. In turn, the advertisement attractiveness model 126 may be derived from a word-level attractiveness model 128. The user click inference engine 102 may further use the word-level attractiveness model 128 to generate a word attractiveness score 114 for each word in the online advertisement 106 based on corresponding attractiveness features. For example, words such as “free”, “save”, “deal”, and “affordable” may be correlated with high word attractiveness scores. Likewise, the user click inference engine 102 may use the advertisement attractiveness model 126 to generate the advertisement attractiveness score 116 for the online advertisement 106 based on the attractiveness features 118.

### Electronic Device Components

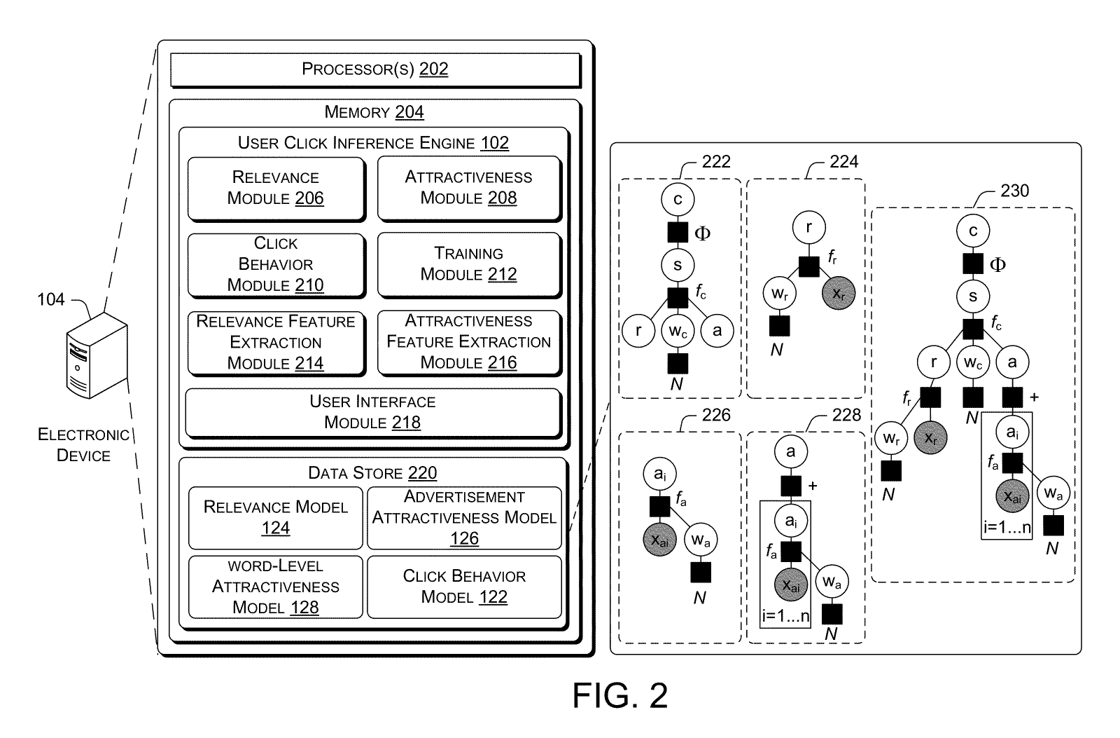

FIG. 2 is an illustrative diagram that shows the example components of a user click inference engine 102. The user click inference engine 102 may be implemented by the computing device 104. In various embodiments, the computing device 104 may be a general purpose computer, such as a desktop computer, a tablet computer, a laptop computer, a server, and so forth. However, in other embodiments, the computing device 104 may be one of a camera, a smart phone, a game console, a personal digital assistant (PDA), or any other electronic device that interacts with a user via a user interface.

The computing device 104 may includes one or more processors 202, memory 204, and/or user controls that enable a user to interact with the electronic device. The memory 204 may be implemented using computer readable media, such as computer storage media. Computer-readable media includes, at least, two types of computer-readable media, namely computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media. The computing device 104 may have network capabilities. For example, the computing device 104 may exchange data with other electronic devices (e.g., laptops computers, servers, etc.) via one or more networks, such as the Internet.

The one or more processors 202 and the memory 204 of the computing device 104 may implement components of the user click inference engine 102. The user click inference engine 102 may include a relevance module 206, an attractiveness module 208, a click behavior module 210, a training module 212, a relevance feature extraction module 214, an attractiveness feature extraction module 216, and a user interface module 218. The memory 204 may also implement a data store 220.

In various embodiments, the user click inference engine 102 may use a factor graph to model user click behavior based on relevance and attractiveness factors. The high-level dependency between user clicks and the relevance and attractiveness factors may be expressed by the factor graph 222. As shown in the factor graph 222, f_{c} is N(w_{c,1}r+w_{c,2}a,β_{c}), and Φ may be a logistic function. Further, node c may represent whether an advertisement is clicked (c=1) or not (c=0).

Accordingly, the click probability, p(c=1), based on the relevance and attractiveness factors may be defined using a logistic function:

$$p ( c = 1 \vert s ) = \frac{1}{1 + {e}^{- s}} , \qquad ( 1 )$$

in which s is the click score, and a larger click score may mean that the advertisement is more likely to be clicked by users. Correspondingly, the non-click probability p(c=0), may be defined as p(c=0|s)=1−1/(1+e^{-s}).

As further shown in the factor graph 222, score s may depend on the relevance score r of an advertisement to the query and the attractiveness score a of the online advertisement. Accordingly, the probability p(s|r,a,w_{c}) may be defined using a Gaussian distribution:

s|r,a,w_{c}:N(w_{c,1}r+w_{c,2}a,β_{c}), (2)

in which the mean of the Gaussian distribution may be the linear combination of the relevance score and the attractiveness score using a two-dimensional weight vector w_{c}. The vector w_{c} may represent the tradeoffs between the relevance and attractiveness factors in their contributions to the overall click score, and β_{c} may represent a hyperparameter controlling precision of clicks, that is, the variance of the Gaussian distribution. Additionally, the weight vector w_{c} may be assumed to have a Gaussian prior:

w_{c}:N(μ_{c},σ_{c}) (3)

As such, given r and a, the click probability for an online advertisement may be estimated as follows:

p(c|r,a)=∫∫p(c|s)p(s|r,a,w_{c})p(w_{c})dw_{c}ds (4)

The relevance module 206 may use the relevance model 124 to estimate the relevance between an online advertisement and a search query inputted by a user. For example, the online advertisement may be the online advertisement 106, and the search query may be the search query 110. The relevance may be quantified by the relevance module 206 as a relevance score.

In various embodiments, the relevance model 124 may be a probabilistic model that is described by an factor graph 224, in which N is N(wᵣ;μᵣ,σᵣ), and fᵣ is N( [symbol] wᵣ,xᵣ [symbol] ,βᵣ). The probabilistic model may assume that there is a relevance score r for each advertisement-query pair. Similar to the click score s introduced earlier, r may also be a Gaussian random variable:

r:N( [symbol] wᵣ,xᵣ [symbol] ,βᵣ) (5)

in which xᵣ may be the relevance features, wᵣ may be a weight variable, and βᵣ may be a hyperparameter controlling the precision of relevance. Further, wᵣ may be assumed to be a Gaussian random variable: wᵣ:N(μᵣ,σᵣ).

In various embodiments, the relevance features xᵣ may include features that the users may see in a sponsored search, such as word frequency, inverse document frequency, topical page rank, and/or so forth, which are extracted by using the query words of a search query and the online advertisement. In other words, relevance features xᵣ may exclude features that are invisible to users, such as bid keywords and/or content of an advertisement landing page.

Thus, given the relevance features xᵣ, the relevance model 124 may be used to obtain a joint probability of r,wᵣ as follows:

p(r,wᵣ|xᵣ)=p(r|wᵣ,xᵣ)p(wᵣ), (6)

in which p(r|wᵣ,xᵣ) is N( [symbol] wᵣ,xᵣ [symbol] ,βᵣ).

Further, if the prior of wᵣ is known, the relevance model 124 may be used to estimate a probability of a relevance score for a query-advertisement pair as follows:

p(r|xᵣ)=∫p(r,wᵣ|xᵣ)dwᵣ (7)

The attractiveness module 208 may use an advertisement attractiveness model 126 to quantify the attractiveness of an online advertisement, such as the online advertisement 106. However, since the attractiveness of an online advertisement depends on the attractiveness of words that are in the online advertisement, the advertisement attractiveness model 126 may be defined based on the word-level attractiveness model 128. The word-level attractiveness model 128 may be used to generate an attractiveness score for each word in an online advertisement.

As shown in FIG. 2, a factor graph 226 for the word-level attractiveness model 128 may be similar to the factor graph 224 of the relevance model 124. In the factor graph 226, N is N(wₐ;μₐ,σₐ), and fₐ is N( [symbol] wₐ,xₐ_{ᵢ} [symbol] ,βₐ). The word-level attractiveness model 128 may use a Gaussian distribution to model the attractiveness score aᵢ of a word i. The Gaussian distribution may take the linear combination of the attractiveness features xₐ_{ᵢ} as its mean and βₐ_{ᵢ} as its variance controlling the precision of attractiveness, as follows:

aᵢ:N( [symbol] wₐ,xₐ_{ᵢ} [symbol] ,βₐ_{ᵢ}) (8)

Further, as in the relevance model 124, wₐ may be a weight vector which has a Gaussian prior: wₐ:N(μₐ,σₐ).

In various embodiments, the attractiveness features 118 that are quantified by the attractiveness module 208 may include two types of features. The first type of features may be textual features, such as the position of each word in an online advertisement, the length of each word, the part of speech (POS) of each word, and so forth. Each word may be tagged using POS tags, such as a Noun tag, a Verb tag, an Adjective tag, an Adverb tag, an Unknown tag, and/or so forth.

The second type of features for each word may be features that are extracted from an online advertisement based on a historic record of user impressions and clicks, which may represent prior user preferences on words in online advertisements provided by an advertisement platform. The advertisement platform may be an advertisement space provided by a specific search engine. The second type of features may include one or more of the following:
adCnt: a number of online advertisements in an online advertisement platform that contain a particular word. For example, if a particular word appears in every online advertisement, the word may not be very attractive to users.
Entropy: −p(x)log p(x), where p(x)=adCnt/|A|, in which |A| indicates the total number of online advertisements in the advertisement platform. Entropy may be used to penalize words that are too generic or too rare.
clickedAdCnt: a number of online advertisements in the advertisement platform that contain a particular word and has been clicked in a time period (e.g., last week).
unclickedAdCnt: a number of online advertisements in the advertisement platform that contain a particular word but has not been clicked in a time period (e.g., last week).
impCnt: a number of impressions of the online advertisements in the advertisement platform that contain a particular word and shown in a time period (e.g., last week).
clickCnt: a number of clicks on the online advertisements of the advertisement platform that contain a particular word in a time period (e.g., last week).
clickRatio, which may be expressed as:

$$\frac{\vert A \vert + clickAdCnt}{\vert A \vert + adCnt} \qquad ( 9 )$$

unclickRatio, which may be expressed as:

$$\frac{\vert A \vert + unclickedAdCnt}{\vert A \vert + adCnt} \qquad ( 10 )$$

wordClickRatio, which may be expressed as:

$$\frac{ClickCnt}{1000 + impCnt} \qquad ( 11 )$$

wordUnclickRatio, which may be expressed as:

$$\frac{impCnt - ClickCnt}{1000 + impCnt} \qquad ( 12 )$$

Accordingly, by using the attractiveness features, the word-level attractiveness model 128 may provide the joint probability of aᵢ,wₐ given attractiveness features xₐ_{ᵢ} as below:

p(aᵢ,wₐ|xₐ_{ᵢ})=p(aᵢ|wₐ,xₐ_{ᵢ})p(wₐ) (13)

in which p(aᵢ|wₐ,xₐ_{ᵢ}) is N( [symbol] wₐ,xₐ_{ᵢ} [symbol] ,βₐ_{ᵢ}).

Further, given that the prior of weight vector wₐ is known, the probability of an attractiveness score for a word may be estimate as follows:

p(aᵢ|xₐ_{ᵢ})=∫p(aᵢ,wₐ|xₐ_{ᵢ})dwₐ (14)

The advertisement attractiveness model 126 may be defined based on the word-level attractiveness model 128. In defining the advertisement attractiveness model 126, the attractiveness score of an online advertisement may be assumed to be a Gaussian random variable. Further, the Gaussian random variable may take a sum of the attractiveness of the words in the online advertisement as its mean:

$$a \vert {\{ {a}_{i} \}}_{i = 1}^{n} : N ( {\sum }_{i = 1}^{n} {a}_{i} , {β}_{a} ) ,$$

in which a is the attractiveness score of an online advertisement, aᵢ is the attractiveness score of the i-th word in the online advertisement, and βₐ is a hyperparameter controlling a precision of attractiveness.

As shown in FIG. 2, a factor graph 228 of the advertisement attractiveness model 126 may be defined in relation to the factor graph 226 of the word-level attractiveness model 128, in which N is N(wₐ;μₐ,σₐ), and fₐ is N( [symbol] wₐ,xₐ_{ᵢ} [symbol] ,βₐ). Accordingly, the factor graph 228 may express the following:

p(a,{aᵢ}ᵢ₌₁ⁿ,wₐ|xₐ)=p(a|{aᵢ}ᵢ₌₁ⁿ)(Πᵢ p(aᵢ|wₐ,xₐ_{ᵢ}))p(wₐ) (15)

in which xₐ={xₐ_{ᵢ}}ᵢ₌₁ⁿ, and n may be the number of words in the online advertisement. By marginalizing {aᵢ}ᵢ₌₁ⁿ and wₐ, a probability of the attractiveness score for an online advertisement may be computed as follows:

p(a|xₐ)=∫∫p(a,{aᵢ}ᵢ₌₁ⁿ,wₐ|xₐ)dwₐd{aᵢ}ᵢ₌₁ⁿ (16).

The click behavior module 210 may use a click behavior model 122 to perform user click behavior analysis. The click behavior model 122 may be generated based on the relevance model 124 and the advertisement attractiveness model 126. As shown in FIG. 2, the click behavior model 122 may be represented by a factor graph 230. In the click behavior model 122, only the node c, xₘ and xₐ={xₐ_{ᵢ}}ᵢ₌₁ⁿ are observable, and all the other nodes are hidden variables. Accordingly, a probability of a click on an online advertisement given the relevance features xᵣ and the word-level attractiveness features xₐ of the online advertisement may be written as follows:

p(c|xᵣ,xₐ)=∫∫p(c|r,a)p(r|xᵣ)p(a|xₐ)drda (17)

in which p(c|r,a) may be defined by equation (4), p(r|xᵣ) by equation (7), and p(a|xₐ) by equation (14).

In various embodiments, the click behavior model 122 may use two categories of parameters in order to perform user click behavior analysis. These two categories may include:

| Category | Parameters |
|---|---|
| A | β_{c}, βᵣ, βₐ, βₐᵢ |
| B | μᵣ, σᵣ, μₐ, σₐ, μ_{c}, σ_{c} |

The parameters in category A may be manually set, and the parameters in category B may be learned from a set of training data. The parameters in category B may have a vector/matrix form whose dimension depends on the dimension of input features. A training module 212 may be used to learn the parameters in category B and facilitate the training of the click behavior model 122.

Thus, given a set of training examples (impression events represented by triples of {xᵣ,xₐ,c}), the training module 212 may learn the parameters in category B by maximizing their likelihood. In each of the triples, xᵣ may be a set of relevance features, xₐ may be a set of attractiveness features, and c may be a ground truth in binary format. For example, c=1 may represent that a corresponding online advertisement was clicked, and c=0 may represent that the corresponding online advertisement was not clicked. The training examples may be collected from sponsored search logs of a search engine for a predetermined time period.

In some embodiments, in order to perform the likelihood estimation in an efficient manner, the training module 212 may exploit an approximate message passing algorithm to train the click behavior model 122. The messages and marginals may be approximated by moment matching to a Gaussian distribution with the same mean and variance using expectation propagation. Such estimation may be achieved by minimizing a Kullback-Leibler divergence between the true and the approximated probabilities. In at least one embodiment, the training of the click behavior model 122 may be accomplished via a framework for running Bayesian inference in graphical models.

The learning of the parameters in the category B may further enable the attractiveness module 208 to use the word-level attractiveness model 128 to obtain an attractiveness score of a word in an online advertisement. In at least one embodiment, the attractiveness score of a word, a*ᵢ, may be inferred as follows:

$${a}_{i}^{*} = arg {max p}_{{a}_{i}} ( {a}_{i} \vert {x}_{{a}_{i}} ) \qquad ( 18 )$$

in which p(aᵢ|xₐ_{ᵢ}) is defined in equation (14).

Likewise, the learning of the parameters in the category B may further enable the attractiveness module 208 to use the advertisement attractiveness model 126 to obtain an attractiveness score of an online advertisement. In at least one embodiment, the attractiveness score of the online advertisement, a*, may be inferred as follows:

$${a}^{*} = arg {max }_{a} p ( a \vert {x}_{a} ) , \qquad ( 19 )$$

in which p(a|xₐ) is defined in equation (16).

The relevance feature extraction module 214 may extract a set of relevance features from each online advertisement that is to be analyzed, such as the online advertisement 106. As described above, the extracted relevance feature may include features that the users may see in a sponsored search, such as term frequency, inverse document frequency, topical page rank, and/or so forth. The features may be extracted by using the query words of a search query and the online advertisement. In some embodiments, the extracted relevance features may exclude features that are invisible to users, such as bid keywords and/or content of an advertisement landing page.

The attractiveness feature extraction module 216 may extract a set of attractiveness features for each word in an online advertisement that is to be analyzed, such as the online advertisement 106. As described above, the extracted attractiveness features for a word may include two types of features. The first type of features may be textual features, such as the position of each word in an online advertisement, the length of each word, the part of speech (POS) of each word, and so forth. The second type of features for each word may be features that are extracted from an online advertisement based on a historic record of user impressions and clicks, which may represent prior user preferences on words in online advertisements.

The user interface module 218 may enable the user to interact with the modules of the user click inference engine 102 using a user interface (not shown). The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

In some embodiments, the user may select online advertisements to be analyzed by the user click inference engine 102 via the user interface module 218. In other embodiments, a user may use the user interface module 218 to manually input category A parameters into the training module 212, and/or upload training examples for learning category B parameters into the training module 212. In still other embodiments, the user interface module 218 may be used to select the types of relevance features and attractiveness features to be analyzed by the user click inference engine 102.

The data store 220 may store the various models that are used by the user click interference engine 102. The stored models may include the relevance model 124, the advertisement attractiveness model 126, the word-level attractiveness model 128, and the click behavior model 122. The data store 220 may further stored the factor graphs 222-230, as well as other data and/or intermediate products that are used by the user click inference engine 102, such as the category A and category B parameters, training examples, search queries, online advertisements to be analyzed. The data store 220 may also store scores generated by the user click inference engine 102. The scores may include word attractiveness scores, advertisement attractiveness scores, relevance scores, and/or probability of clicks for online advertisements.

### Example Processes

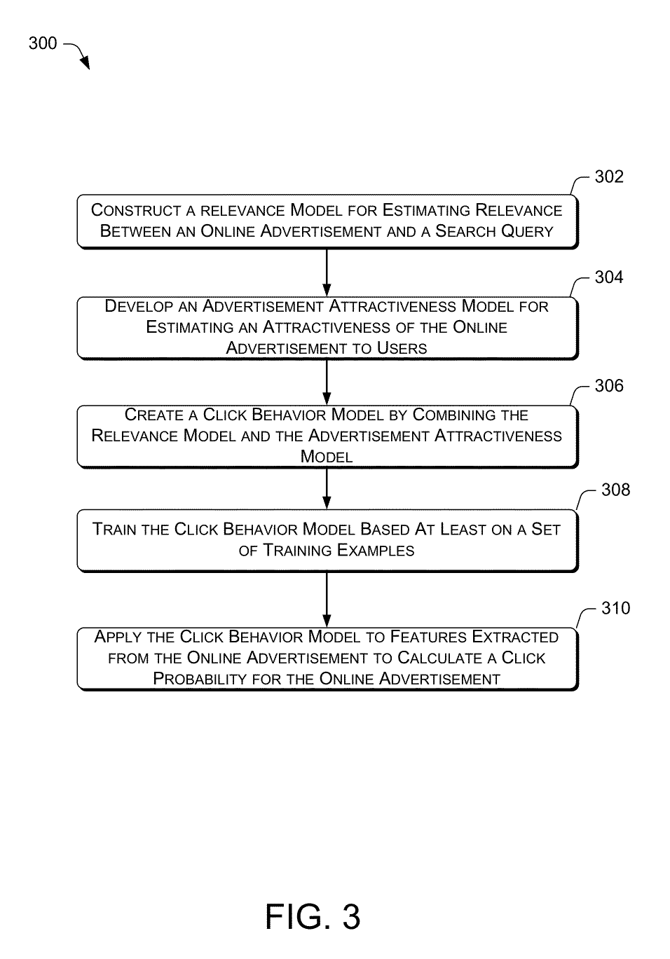

FIGS. 3-5 describe various example processes for implementing attractiveness-based online advertisement click prediction. The order in which the operations are described in each example process is not intended to be construed as a limitation, and any number of the described operations can be combined in any order and/or in parallel to implement each process. Moreover, the operations in each of the FIGS. 3-5 may be implemented in hardware, software, and a combination thereof. In the context of software, the operations represent computer-executable instructions that, when executed by one or more processors, cause one or more processors to perform the recited operations. Generally, computer-executable instructions include routines, programs, objects, components, data structures, and so forth that cause the particular functions to be performed or particular abstract data types to be implemented.

FIG. 3 is a flow diagram that illustrates an example process 300 for developing and using a click behavior model to infer a click probability of an online advertisement. The online advertisement may be the online advertisement 106. At block 302, the relevance model 124 for estimating relevance between an online advertisement and a query may be constructed for use by the relevance module 206. In various embodiments, the relevance model 124 may be a probabilistic model that is described by the factor graph 224.

The relevance model 124 may be constructed to quantify a set of relevance features that are visible to users, such as term frequency, inverse document frequency, topical page rank, and/or so forth, which are extracted by using the query words of a search query and the online advertisement. In some embodiments, the relevance features may exclude features that are invisible to users, such as bid keywords and/or content of an advertisement landing page.

At block 304, the advertisement attractiveness model 126 for estimating an attractiveness of the online advertisement to users may be developed for use by the attractiveness module 208. In various embodiments, the advertisement attractiveness model 126 may be a probabilistic model that is described by the factor graph 228.

At block 306, the click behavior model 122 may be created by combining the relevance model 124 and the advertisement attractiveness model 126. In various embodiments, the click behavior model 122 may be represented by the factor graph 230. The click behavior model 122 may use two categories of parameters in order to perform user click behavior analysis, in which the parameters in a first category may be manually set, while the parameters in a second category may be learned from a set of training data.

At block 308, the click behavior model 122 may be trained. The click behavior model 122 may be trained with the manual setting of the parameters in the first category. Additionally, the training module 212 may further train the click behavior model 122 by obtaining the parameters in the second category from a set of training examples by maximizing the likelihood of the training examples. In some embodiments, in order to perform the likelihood estimation in an efficient manner, the training module 212 may exploit an approximate message passing algorithm to train the click behavior model 122.

At block 310, the click behavior module 210 may apply the click behavior model 122 to features of an online advertisement, such as the online advertisement 106, to calculate a click probability of the online advertisement. The features of the online advertisement 106 may include the attractiveness features 118 and the relevance features 120. The click probability may be further reported to the online advertiser that provided the online advertisement 106 so that the online advertiser may improve the content of the online advertisement 106. For example, the online advertiser may modify the online advertisement to include additional words that are more appealing to users.

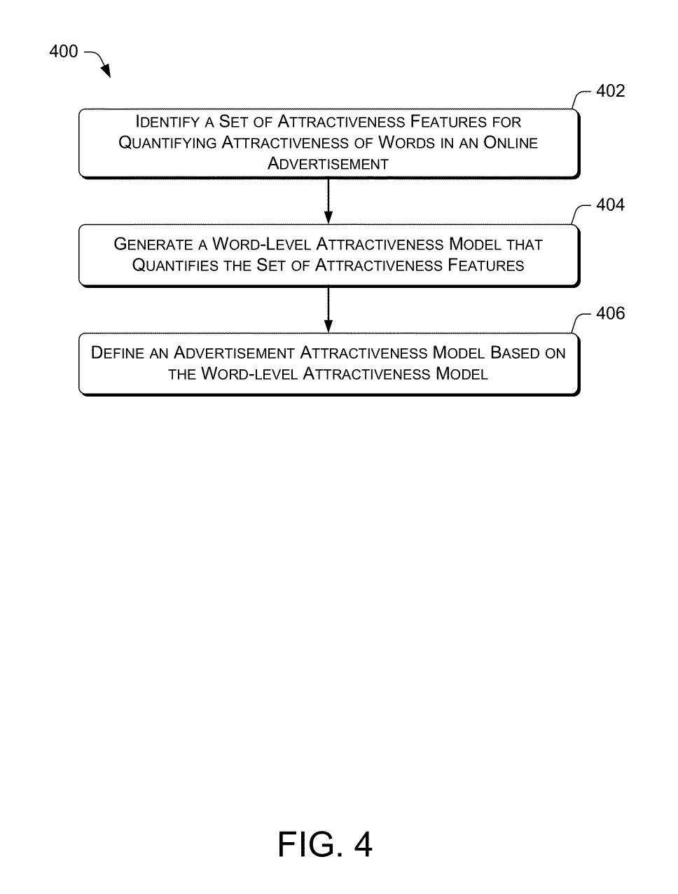

FIG. 4 is a flow diagram that illustrates an example process 400 for generating a word-level attractiveness model and an advertisement attractiveness model. The example process 400 may further illustrate block 304 of the process 300.

At block 402, a set of attractiveness features for quantifying attractiveness of words in an online advertisement may be identified. In various embodiments, the attractiveness features may include two types of features. The first type of features may be textual features, such as the position of each word in an online advertisement, the length of each word, the part of speech (POS) of each word, and so forth. The second type of features may be features that are identified based on a historic record of user impressions and clicks, which may represent prior user preferences for online advertisements and words in online advertisements.

At block 404, the word-level attractiveness model 128 that quantifies the set of attractiveness features may be generated. In various embodiments, the click behavior model 122 may be represented by the factor graph 226. The word-level attractiveness model 128 may use a Gaussian distribution to model the attractiveness scores of words in an online advertisement. In some embodiments, the word-level attractiveness model 128 may be used to generate an attractiveness score for each word in the online advertisement.

At block 406, the advertisement attractiveness model 126 may be defined based on the word-level attractiveness model 128. In defining the advertisement attractiveness model 126, the attractiveness score of an online advertisement may be assumed to be a Gaussian random variable. The advertisement attractiveness model 126 may be used to generate the advertisement attractiveness score 116 for an online advertisement.

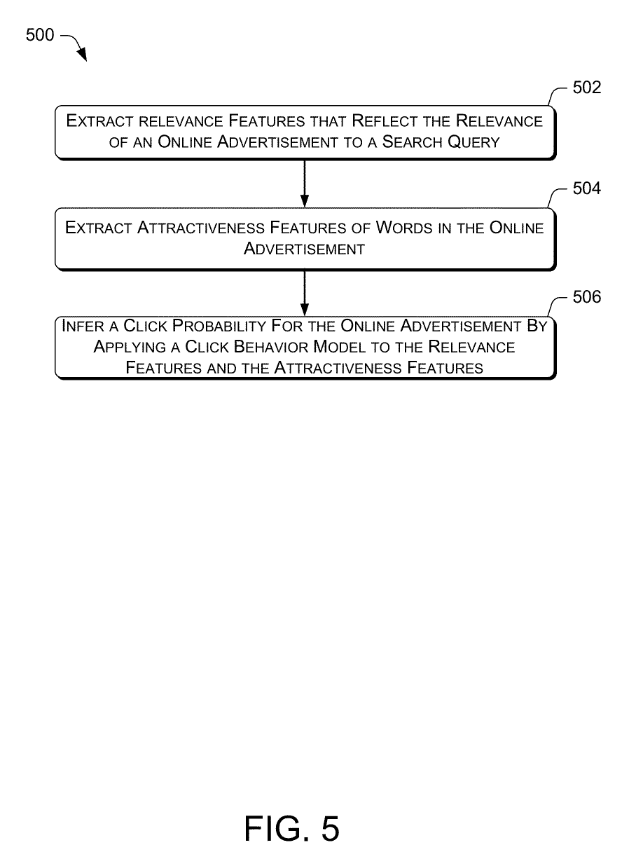

FIG. 5 is a flow diagram that illustrates an example process 500 for inferring a click probability of an online advertisement based on relevance features and attractiveness features of an online advertisement. The example process 400 may further illustrate block 308 of the process 300. The online advertisement may be the online advertisement 106.

At block 502, the relevance feature extraction module 214 may extract relevance features 120 that reflect the relevance of the online advertisement 106 to a search query, such as the search query 110. The extracted relevance features 120 may include features that are visible to users, such as word frequency, inverse document frequency, topical page rank, and/or so forth, which are extracted by using the query words of a search query 110 and the online advertisement 106.

At block 504, the attractiveness feature extraction module 216 may extract attractiveness features 118 of word in the online advertisement 106. In various embodiments, the extracted attractiveness features may include two types of features. The first type of features may be textual features, such as the position of each word in an online advertisement, the length of each word, the part of speech (POS) of each word, and so forth. The second type of features may be features that are identified based on a historic record of user impressions and clicks, which may represent prior user preferences for online advertisements and words in online advertisements.

At block 506, the click behavior module 210 may infer a click probability for the online advertisement 106 by applying a click behavior model, such as the click behavior model 122, to the relevance features 120 and the attractiveness features 118 of the online advertisement 106.

In additional embodiments, the attractiveness module 208 may further use the word-level attractiveness model 128 to generate a word attractiveness score 114 for each word in the online advertisement 106 based on the attractiveness features 118. Likewise, the attractiveness module 208 may also use the advertisement attractiveness model 126 to generate the advertisement attractiveness score 116 for the online advertisement 106 based on the attractiveness features 118.

The attractiveness of an online advertisement is dependent on the ability of the words in the online advertisement to attract the attention of a user. The techniques describes herein may provide a way to quantify the attractiveness of an online advertisement, and predict a probability that a user may click on the online advertisement based on the attractiveness of the advertisement in conjunction with the relevance of the online advertisement to a search query. Accordingly, rather than simply improving the relevance of their online advertisement to user search queries, the online advertisers may alternatively or concurrently use the click probabilities of online advertisements to improve the content attractiveness of their online advertisements to increase the number of user clicks. For example, words such as “free”, “save”, “deal”, and “affordable” may be used to increase the appeal of online advertisements to consumers.

### Conclusion

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

What is claimed is:

1. A computer-implemented method, comprising:
developing an advertisement attractiveness model for estimating an attractiveness of an online advertisement;
creating a click behavior model by combining the advertisement attractiveness model with a relevance model for estimating relevance between the online advertisement and a search query; and
applying the click behavior model to features extracted from the online advertisement to calculate a click probability for the online advertisement.

2. The computer-implemented method of claim 1, wherein the click behavior model uses a first set of parameters and a second set of parameters, further comprising training the click behavior model by manually setting the first set of parameters and obtaining the second set of parameters by maximizing likelihood of a set of training examples.

3. The computer-implemented method of claim 2, wherein an example in the set of training examples is an impression event represented by triples of {xᵣ,xₐ,c}), in which xᵣ is a set of relevance features, xₐ is a set of attractiveness features, and c is a click ground truth in binary format.

4. The computer-implemented method of claim 1, further comprising applying the advertisement attractiveness model to attractiveness features extracted from the online advertisement to calculate an advertisement attractiveness score that quantifies an appeal of the online advertisement.

5. The computer-implemented method of claim 1, wherein the developing include defining the advertisement attractiveness model from a word-level attractiveness model that is used for quantifying an appeal of each word in the online advertisement.

6. The computer-implemented method of claim 5, further comprising applying the word-level attractiveness model to attractiveness features of a word in the online advertisement to calculate a word attractiveness score for the word.

7. The computer-implemented method of claim 1, wherein the features include attractiveness features that comprise textual features of words in the online advertisement and derived features of words that are defined based on previous user impressions and user clicks on other online advertisements.

8. The computer-implemented method of claim 7, wherein the textual features include at least one of positions of the words in the online advertisement, lengths of the words in the online advertisement, or parts of speech that correspond to the words in the online advertisement.

9. The computer-implemented method of claim 7, wherein the derived features of a word include at least one of:
a number of online advertisements in an advertisement platform that contain the word;
an entropy of the word in relation to a total number of the online advertisements in the advertisement platform;
a number of online advertisements in the advertisement platform that contain the word and have been clicked in a time period;
a number of impressions of online advertisements in the advertisement platform that contain the word and shown in the time period; or
a number of clicks on online advertisements in the advertisement platform that contain the word in the time period.

10. The computer-implemented method of claim 7, wherein the derived features of a word include at least one of a click ratio or an unclick ratio, wherein the click ratio is represented by:
$$\frac{\vert A \vert + clickAdCnt}{\vert A \vert + adCnt}$$
and the unclick ratio is represented by:
$$\frac{\vert A \vert + unclickedAdCnt}{\vert A \vert + adCnt}$$
wherein |A| indicates a number of online advertisements in an advertisement platform, clickAdCnt is a number of online advertisements in the advertisement platform that contain the word and have been clicked in a time period, unclickedAdCnt is a number of online advertisements in the advertisement platform that contain the word but has not been clicked in a time period, and adCnt is a number of online advertisements in the advertisement platform that contain the word.

11. The computer-implemented method of claim 7, wherein the derived features of a word include at least one of a word click ratio or a word unclick ratio, wherein the word click ratio is represented by:
$$\frac{ClickCnt}{1000 + impCnt}$$
and the word unclick ratio is represented by:
$$\frac{impCnt - ClickCnt}{1000 + impCnt}$$
wherein ClickCnt is a number of clicks on online advertisements of an advertisement platform that contain the word in a time period, and impCnt is a number of impressions of online advertisements in the advertisement platform that contain the word and shown in the time period.

12. The computer-implemented method of claim 1, wherein the features include relevance features that quantify relevance of the online advertisement to the search query, the relevance features excluding a relevance feature that is invisible to a user that provided the search query.

13. A computer-readable medium storing computer-executable instructions that, when executed, cause one or more processors to perform acts comprising:
storing a click behavior model that is derived from a combination of an advertisement attractiveness model for estimating an attractiveness of an online advertisement and a relevance model for estimating relevance between the online advertisement and a search query;
extracting attractiveness features and relevance features from the online advertisement; and
applying the click behavior model to the attractiveness features and the relevance features to calculate a click probability for the online advertisement.

14. The computer-readable medium of claim 13, wherein the click behavior model uses a first set of parameters and a second set of parameters, further comprising training the click behavior model by manually setting the first set of parameters and obtaining the second set of parameters by maximizing likelihood of a set of training examples.

15. The computer-readable medium of claim 14, wherein an example in the set of training examples is an impression event represented by triples of {xᵣ,xₐ,c}), in which xᵣ is a set of relevance features, xₐ is a set of attractiveness features, and c is a click ground truth in binary format.

16. The computer-readable medium of claim 13, wherein the advertisement attractiveness model is developed from a word-level attractiveness model that is used for quantifying an appeal of each word in the online advertisement.

17. The computer-readable medium of claim 13, wherein the attractiveness features comprise textual features of words in the online advertisement and derived features of words that are defined based on previous user impressions and user clicks on other online advertisements, and wherein the relevance features quantify relevance of the online advertisement to the search query.

18. A computing device, comprising:
one or more processors; and
a memory that includes a plurality of computer-executable components, the plurality of computer-executable components comprising:
an attractiveness component that applies an advertisement attractiveness model to attractiveness features extracted from an online advertisement to calculate an advertisement attractiveness score that quantifies an appeal of the online advertisement; and
a click behavior component that applies a click behavior model to the attractiveness features and relevance features extracted from the online advertisement to calculate a click probability for the online advertisement,
the advertisement attractiveness model is derived from a word-level attractiveness model for quantifying the appeal of each word in the online advertisement.

19. The computing device of claim 18, further comprising a relevance component that applies a relevance model to the relevance features extracted from the online advertisement to calculate relevance of the online advertisement to a search query.

20. The computing device of claim 19, wherein the attractiveness component further applies the word-level attractiveness model to attractiveness features of a word in the online advertisement to calculate a word attractiveness score for the word.
